(19) United States
(12) Patent Application Publication
(10) Pub. No.: US 2016/0309700 A1
(43) Pub. Date: Oct. 27, 2016

(54) Friction Pan Call Having a Sound Board with Multiple Vibrational Regions

(71) Applicant: Hunters Specialties, Inc., Cedar Rapids, IA (US)

(72) Inventors: Scott Thomas, Marion, IA (US); Rick White, Cedar Rapids, IA (US); Steve Cobb, Union, SC (US); Ron Bean, Cedar Rapids, IA (US)

(73) Assignee: Hunters Specialties, Inc., Cedar Rapids, IA (US)

(21) Appl. No.: 15/134,614

(22) Filed: Apr. 21, 2016

Related U.S. Application Data
(60) Provisional application No. 62/151,187, filed on Apr. 22, 2015.

(51) Int. Cl. A01M 31/00

(52) U.S. Cl. CPC A01M 31/004

(57) ABSTRACT

A game call device generally comprising a pan assembly which includes a frame combined with a striking plate and a sounding board. The striking plate has an external surface adapted to be struck by a striking member. The sounding board has at least two vibrational regions separated by one or more openings. In use, the striking member is manually slid over the striking surface to cause the sounding board vibrational regions to vibrate simulating the sounds of turkeys and other game birds.

### BACKGROUND

This application claims priority under 35 U.S.C. §119 to provisional application Ser. No. 62/151,187, filed Apr. 22, 2015, which is hereby incorporated by reference in its entirety.

The present invention relates to game calls, and more specifically, to an improved friction turkey pan call having a sounding board with multiple vibrational regions.

Hunting wild turkeys is a popular type of hunting in North America. The number of turkeys has increased dramatically with conservation and wildlife programs, thereby increasing hunting. Normally, the male turkey, the gobbler, gives a call to attract hens for mating. In hunting, the sequence is reversed and the hunter attempts to lure the gobbler by mimicking hen turkey sounds. The reversal of the normal mating process doesn't always work and the quality of the hunter's calling influences the success of the hunt.

Friction type turkey calls (also referred to as “pan” or “slate” calls) are the most commonly used turkey call in the United States. The friction type turkey call includes a striking plate that produces artificial turkey sounds due to contact by and relative movement with a rigid striking rod or striking member. Sounds are made by scraping the striking member over the surface of the striking plate which vibrates the frame and/or an internal sounding board. A number of factors can contribute to the sound produced by a friction or slate turkey call. These factors may include the composition of the striking surface, whether slate or ceramic, the material of the striker, whether wood or synthetic, and the composition of the pan frame. The composition and type of sounding board, and the quantity and position of the holes in the bottom of the pan frame are additional factors that affect the quality and type of sound produced by the turkey call.

In use, a user holds the pan frame in one hand (usually the non-dominant hand), and uses the other hand to scrape the striking member over the striking surface of the turkey call device. When the surface is scratched, the pan frame of the turkey call and the sounding board vibrate, producing resonance and overtones that sound like the hen turkey. Among the problems encountered with existing friction turkey calls is that the sounding boards are typically made of a solid one-piece material adapted to vibrate around its outer edge. The one-piece sounding board typically creates only a single tone. However, to mimic the sound of a hen it is desirable to emit multiple tones.

There remains, therefore, a need for an improved turkey call, and in particular, an improved turkey call in which the internal sounding board creates multiple tones, thus producing a more natural turkey sound.

### SUMMARY

According to its major aspects and broadly stated, the present invention relates to a game call device generally comprising a pan assembly which includes a frame combined with a striking plate and a sounding board. The striking plate has an external surface adapted to be struck by a striking member. The sounding board has at least two vibrational regions separated by one or more openings. The openings may be in the center portion of the sounding board or around its outer edge. The vibrational regions are capable of independently vibrating to simulate the sounds of turkeys and other game birds.

In one embodiment the sounding board is combined with the pan frame near the outer edge of the sounding board at a connection point. The connection point may extend around the entire periphery of the sounding board. In this embodiment, the vibrations in the sounding board occur between the connection point and the center/middle of the sounding board. In other words, the vibrations do not occur around the outside edge of the sounding board but instead occur at some point closer to the center of the sounding board. In other embodiments the connection point may be somewhere other than around the outside edge of the sounding board thereby allowing the outer edge to vibrate and produce sound.

According to another major aspect and broadly stated, the present invention relates to a method of using a game call device which generally comprising a pan assembly and a striking member. The pan assembly includes a frame combined with a striking plate and a sounding board. The sounding board has one or more openings dividing it into at least two separate vibrational regions. The method includes taking the game call device and sliding the striking member over the surface of the striking plate causing the at least two separate vibrational regions to independently vibrate simulating the sounds of turkeys and other game birds. The method may further include actuating a dampening member to selectively dampen the vibration of one of the sounding board's vibrational regions.

### BRIEF DESCRIPTION OF THE DRAWINGS

FIG. 1 is a perspective view of an embodiment of the pan call invention;

FIG. 2 is a top view of the pan frame shown with the striking surface and sounding board removed;

FIG. 3 is a section view of an embodiment of the invention taken along lines A-A in FIG. 2;

FIG. 4 is a top view of a first sounding board;

FIG. 5 is a top view of a second sounding board;

FIG. 6 is a top view of a third sounding board;

FIG. 7 is a section view of an embodiment of the invention using the third sounding board shown in FIG. 6; and

FIG. 8 is a section view of an embodiment having dampening members to selectively dampen one or more vibrational regions.

### DETAILED DESCRIPTION

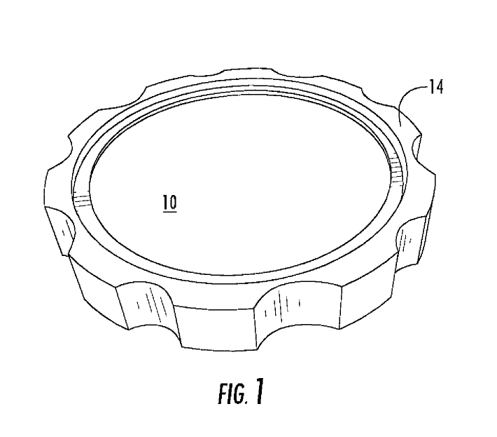

With reference now to the drawings, the components of the present invention will be described. Referring to FIGS. 1-4, the present invention in one embodiment is a friction type game call device having a pan assembly. The pan assembly generally includes a pan frame 14 combined with a striking surface 10 and a sounding board 42. The pan frame 14 is a housing which may include openings 17 in its sides and/or bottom 15 to help project sound outwardly from the device. The striking surface 10 forms an outer surface of the pan assembly allowing a user to slide a striking member (not shown) over its surface. Together, the striking surface 10 and pan frame 14 enclose the internally positioned sounding board 42. In some embodiments the striking surface 10 is at least partially transparent thereby allowing the sounding board 42 to be seen beneath the striking surface 10. As shown in FIG. 3, there is a gap above the sounding board 42 between the striking surface 10 and the sounding board 42 and a gap below the sounding board 42 between the frame bottom 15 and the sounding board 42. These gaps allow space for the sounding board 42 to vibrate as shown by the arrows in FIGS. 3, 7, and 8.

Preferably, the striking surface 10 is formed of slate, glass, ceramic material, metal, such as, for example, aluminum, or any other suitable material or combination of these materials, in order to best obtain the desired artificial sounds. The pan frame 14 can be formed of glass, frictionite, carbon, wood, plastic, or other suitable materials. The striking member can be made out of different types of wood, plastic, and carbon, as is known in the art. Preferably, the sounding board 42 is formed from aluminum, however, it may be formed from wood, plastic, glass, or any other suitable material capable of resonating the simulated turkey call sounds. Further, although the components 10, 14, 42 are shown as being generally circular-shaped; they may be any other suitable size or shape.

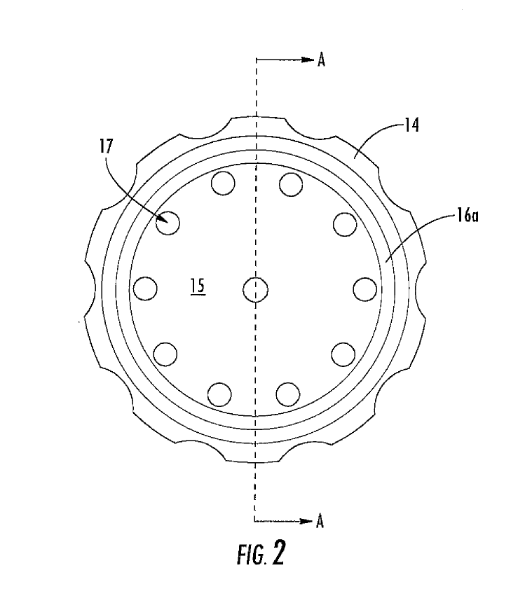

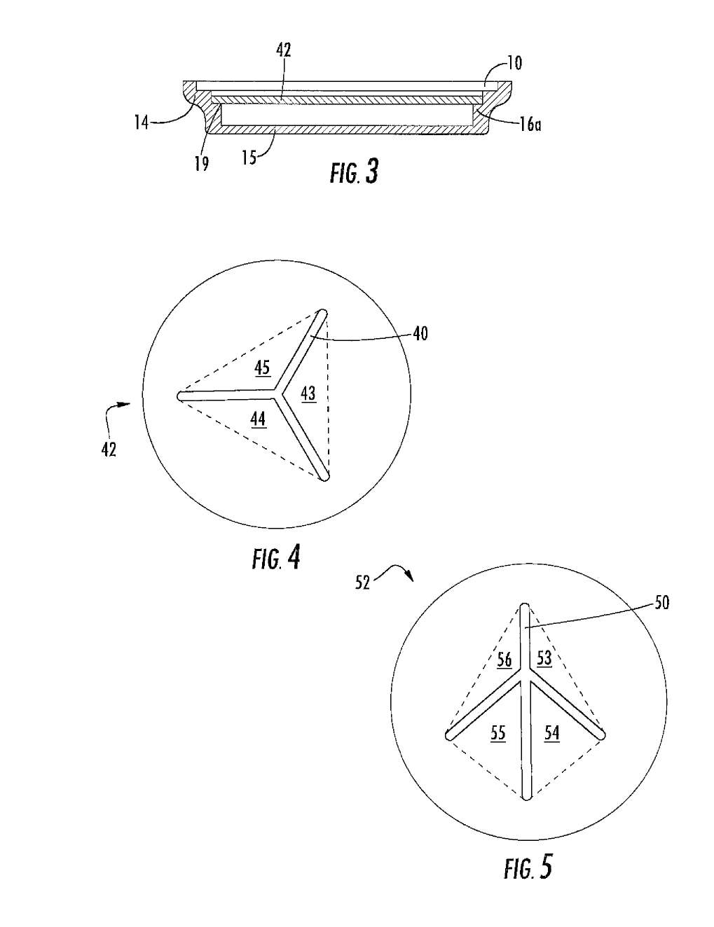

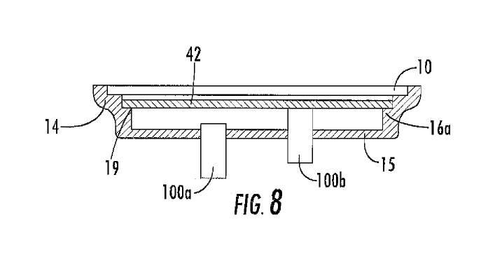

As explained in more detail below, openings 40 in the sounding board 42 create multiple vibrational regions within a single sounding board 42. In the embodiment shown in FIG. 4, the sounding board 42 is combined with the pan frame 14 near the outer edge of the sounding board 42 at a connection point 19. The vibrations in the sounding board 42 occur between the connection point 19 and the center/middle of the sounding board 42. The connection point 19 is between the outer most portion of the opening 40 and the outside edge of the sounding board 42 to prevent the pan frame 14 from dampening the sounding board's 42 vibrations. One means of connecting the sounding board 42 to the pan frame 14 is shown in FIGS. 2 and 3 wherein the pan frame 14 includes a ledge portion 16a having a size/diameter smaller than the size/diameter of the sounding board 42. This allows the outer edge of the sounding board 42 to rest on the ledge portion 16a, which extends around the entire periphery of the sounding board 42. In other embodiments, like the one shown in FIG. 7 which is described below in more detail, the sounding board 42 is combined with the pan frame 14 by posts or other members 16b which extend upward from the frame bottom 15. In these alternate embodiments the members 16b are not necessarily combined with the outer edges of the pan frame 14 and do not necessarily contact the sounding board 42 around its entire periphery thereby allowing the outer edge of the sounding board 42 to vibrate.

As shown in FIG. 4, the sounding board 42 includes multiple vibrational regions 43, 44, 45 separated by one or more openings 40. The vibrational regions 43, 44, 45 are generally defined as the portion of the sounding board 42 between the opening 40 and each respective dashed line since these are the portions of the sounding board 42 which vibrate to produce the most sound. As shown, the vibrational regions 43, 44, 45 are separated by one or more openings 40, however, the vibrational regions 43, 44, 45 may be connected by the mass of the sounding board 42 at their base just like the tines of a tuning fork which vibrate independently but are connected at their base. In the embodiment shown in FIG. 4, three equal vibrational regions 43, 44, 45 are created by the longitudinal openings 40. The vibrational regions 43, 44, 45 independently vibrate to produce sound upon application of the striking member to the striking surface 10. These vibrational regions 43, 44, 45 may all be made from the same material or they may be made from different materials to obtain different sounds/tones. Further, the vibrational regions 43, 44, 45 may all have the same density and thickness or they may have different densities and thicknesses to obtain different sounds/tones.

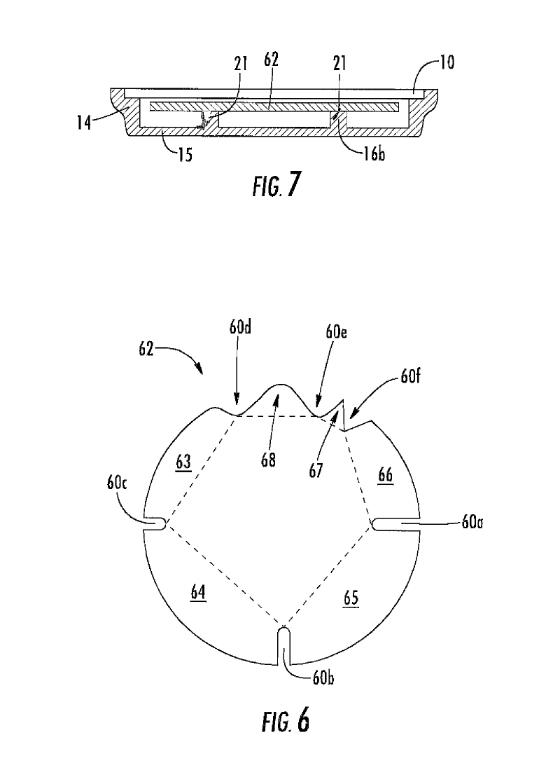

FIGS. 5 and 6 show alternate embodiments of sounding boards having multiple vibrational regions. FIG. 5 shows an embodiment similar to the embodiment described above for FIG. 4 wherein the vibrational regions 53, 54, 55, 56 are located between the outer edge and the center of the sounding board 52. The primary difference in this sounding board 52 is that the shape of the opening 50 looks like a turkey footprint and creates four vibrational regions 53, 54, 55, 56 having different sizes and shapes. Vibrational regions 53 and 56 are a first size and shape and vibrational regions 54 and 55 are a second size and shape. In the embodiment shown in FIG. 6, the openings are notches cut in the outer edge of the sounding board 62 which creates vibrational regions at the outer edge of the sounding board 52. Changing the shape of the opening or the number of openings changes the size and shape of the resultant vibrational regions which creates a different sound.

The sounding boards shown in FIGS. 4, 5, and 6 are exemplary with respect to the shape of the opening created therein. The invention is not limited to any specific number of openings or any opening having a particular shape or size. In some embodiments the openings extend across an entire portion of the sounding board thereby effectively cutting the one sounding board into two separate sounding boards.

FIG. 7 shows an embodiment wherein a sounding board 62 like the one shown in FIG. 6 is combined with the pan frame 14 at a connection point 21, which is closer to the center of the sounding board 62 than the connection point 19 described with respect to FIGS. 2-5. In this embodiment the vibrational regions 63, 64, 65, 66, 67, 68 are positioned between the connection point 21 and the outer edge of the sounding board 62. As shown in FIG. 6, the openings 60a, 60b, 60c, 60d, 60e, 60f may by formed by removing some material from the perimeter of the sounding board 62 to create a notch or cutaway. These notched openings 60a, 60b, 60c, 60d, 60e, 60f create vibrational regions 63, 64, 65, 66, 67, 68 around the external perimeter of the sounding board 62. As explained above, any suitable number and shape of vibrational regions may be used and the invention is not limited to number of shape of the vibrational regions 63, 64, 65, 66, 67, 68 shown in FIG. 6.

One means for connecting the sounding board 62 to the pan frame 14 is shown in FIG. 7 wherein support members 16b extend upward from the bottom 15 of the pan frame 14 to support the sounding board 62. The support members 16b may be one or more posts which may be a molded part of the pan frame 14 or may be members separate from the pan frame 14. The support members 16b may also be a ring raised above the bottom 15 of the pan frame 14 similar to ledge portion 16a in the previous embodiments but having a smaller diameter relative to the overall diameter of the device in order to allow the outer edge of the sounding board 62 to vibrate. In contrast to the embodiments described above with respect to FIGS. 2-5, the support members 16b are located between the inner most portion of the openings 60a, 60b, 60c, 60d, 60e, 60f and the center of the sounding board 62 so most of the vibration/sound is generated between the support members 16b and the outer edge of the sounding board 62 as shown by the arrows in FIG. 7.

FIG. 8 shows an alternate embodiment comprising one or more dampening members 100a, 100b which may be selectively actuated by the user to dampen one or more vibrational regions. The dampening members 100a, 100b have a first end adapted to contact one of the at least two vibrational regions and a second end adapted to be manually actuated by a user. The dampening members 100a, 100b have a retracted position and an extended position. Dampening member 100a is shown in its retracted position wherein it does not contact the sounding board 42, 52, 62 and dampening member 100b is shown in its extended position wherein it contacts the sounding board 42, 52, 62. In the extended position, one end of the dampening member 100b makes contact with one or more of the vibrational regions on the sounding board 42, 52, 62 to dampen the vibrations in that one or more vibrational regions. Dampening the one or more vibrational regions allows the user to selectively change the sound created by the device. In one embodiment the dampening members 100a, 100b are biased in their retracted position by a spring or other suitable member.

The present invention also includes a method of using the game call device described above. The game call device generally comprising a pan assembly and a striking member. The pan assembly includes a frame 14 combined with a striking plate 10 and a sounding board 42, 52, 62. The sounding board 42, 52, 62 has one or more openings dividing it into at least two separate vibrational regions. The method includes taking the game call device and sliding the striking member over the surface of the striking plate 10 causing the at least two separate vibrational regions to independently vibrate simulating the sounds of turkeys and other game birds. The method may further include actuating a dampening member 100a, 100b to selectively dampen the vibration of one of the sounding board's 42, 52, 62 vibrational regions.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

1. A friction pan call comprising:
a pan frame;
a striking surface combined with the pan frame;
a sounding board combined with the pan frame, wherein the sounding board has at least two vibrational regions separated by at least one opening.

2. The friction pan call of claim 1 wherein the sounding board has an outer edge and a middle portion.

3. The friction pan call of claim 2 wherein the sounding board is combined with the pan frame at a connection point and the vibrational regions are between the sounding board middle portion and the connection point.

4. The friction pan call of claim 2 wherein the sounding board is combined with the pan frame at a connection point and the vibrational regions are between the sounding board outer edge and the connection point.

5. The friction pan call of claim 2 wherein the at least one opening is in the middle portion.

6. The friction pan call of claim 2 wherein the at least one opening is in the outer edge.

7. The friction pan call of claim 1 further comprising a dampening member combined with the pan frame, said dampening member movable between a retracted position and an auctuated position.

8. The friction pan call of claim 7 wherein the dampening member is biased in its retracted position.

9. The friction pan call of claim 7 wherein the dampening member has a first end adapted to contact one of the at least two vibrational regions and a second end adapted to be manually actuated by a user.

10. The friction pan call of claim 1 wherein the pan frame has a bottom portion and a side portion and wherein at least one of the bottom portion and the side portion have openings to help project sound outwardly from the sounding board.

11. The friction pan call of claim 1 wherein a first vibrational region of the at least two vibrational regions produces a first tone and a second vibrational region of the at least two vibrational regions produces a second tone.

12. The friction pan call of claim 1 wherein the striking surface is at least partially transparent allowing the sounding board to be seen through the striking surface.

13. A friction pan call comprising:
a pan frame;
a striking surface combined with the pan frame;
a sounding board combined with the pan frame and having an outer edge and a middle portion, wherein the sounding board has a first vibrational region capable of producing a first tone and a second vibrational region capable of producing a second tone.

14. The friction pan call of claim 13 wherein the first vibrational region and second vibrational region are separated by an opening.

15. The friction pan call of claim 13 wherein the first vibrational region is capable of vibrating independently from the second vibrational region.

16. The friction pan call of claim 13 wherein the sounding board has an outer edge and a middle portion.

17. The friction pan call of claim 16 wherein the sounding board is combined with the pan frame at a connection point and the first vibrational region and second vibrational region are between the sounding board middle portion and the connection point.

18. The friction pan call of claim 16 wherein the sounding board is combined with the pan frame at a connection point and the first vibrational region and second vibrational region are between the sounding board outer edge and the connection point.

19. The friction pan call of claim 14 wherein the at least one opening is in the middle portion.

20. The friction pan call of claim 14 wherein the at least one opening is in the outer edge.

21. A method of using a friction pan call having a pan frame, a striking surface, and a sounding board with at least two vibrational regions, said method comprising:
moving a striking member over the striking surface;
causing the at least two vibrational regions to independently vibrate simulating the sounds of turkeys and other game birds.

22. The method of claim 21 further comprising the step of actuating a dampening member to restrict vibration of one of the at least two vibrational regions.

23. The method of claim 21 further comprising the step of causing a first of the at least two vibrational regions to vibrate at a first tone and a second of the at least two vibrational regions to vibrate at a second tone.
